(19) United States
(12) Patent Application Publication
(10) Pub. No.: US 2025/0117978 A1
(43) Pub. Date: Apr. 10, 2025

(54) COLORIZATION OF IMAGES AND VECTOR GRAPHICS

(71) Applicant: ADOBE INC., SAN JOSE, CA (US)

(72) Inventors: Arshdeep Singh Chugh, New Delhi (IN); Sumit Chaturvedi, New Haven, CT (US); Keerti Harpavat, Rajasthan (IN); Vineet Batra, Delhi (IN)

(21) Appl. No.: 18/482,599

(22) Filed: Oct. 6, 2023

(51) Int. Cl. G06T 11/00; G06T 7/50; G06T 7/90

(52) U.S. Cl. CPC G06T 11/001; G06T 7/50; G06T 7/90; G06T 2207/10024

(57) ABSTRACT

Embodiments for colorizing images, including pixel-format images and vector-format images, include obtaining input data including an outline image and a color hint. The color hint includes a colored portion corresponding to a region of the outline image. Then, embodiments process the input data to obtain control guidance for an image generator using an outline encoder. Embodiments generate a synthesized image based on the control guidance using an image generator. The synthesized image depicts an object having a shape based on the outline image and a color based on the color hint. In some cases, embodiments also transfer the colors from the synthesized image to a base vector image to produce a colorized vector image.

### BACKGROUND

The following relates generally to image processing, and particularly to vector image colorization. Vector image colorization includes processes for adding or changing colors in vector images. Some techniques include rule-based computer vision techniques such as outline colorization and color propagation to facilitate the colorization of vector images and line drawings, which are sometimes used in various design workflows. In some cases, machine learning (ML) models can be used to automate this process, analyzing and interpreting line drawings to apply appropriate color values to different segments within a vector image. Vector colorization is used in different industries including animation, graphic design, and digital artistry to convert monochromatic line drawings into colored versions, aiding in the conceptual stages of design projects.

### SUMMARY

Systems and methods for colorizing pixel-based images and for colorizing vector images are described. Embodiments of the present disclosure include a colorization apparatus configured to generate a synthesized image based on an outline image and color hints. Color hints are color additions provided by a user on top of the outline image. Embodiments include an outline encoder configured to encode the outline image and the color hints to produce a conditional embedding that an image generator uses as a basis for generating the synthesized image. Some embodiments further include a color mapping component, which transfers the colors from the pixel-based synthesized image to a vector image.

A method, apparatus, non-transitory computer readable medium, and system for image colorization are described. One or more aspects of the method, apparatus, non-transitory computer readable medium, and system include obtaining an outline image and a color hint, wherein the color hint comprises a colored portion corresponding to a region of the outline image; processing, using an outline encoder, the outline image and the color hint to obtain control guidance for an image generator; and generating, using the image generator, a synthesized image based on the control guidance, wherein the synthesized image depicts an object having a shape based on the outline image and a color based on the color hint.

A method, apparatus, non-transitory computer readable medium, and system for image colorization are described. One or more aspects of the method, apparatus, non-transitory computer readable medium, and system include obtaining training data including a training outline image, a training color hint, and a ground-truth colored image corresponding to the training outline image and the training color hint; initializing an outline encoder using parameters of an image generator; and training the outline encoder, using the training outline image and the training color hint, to generate control guidance for the image generator for generating colored images.

An apparatus, system, and method for image colorization are described. One or more aspects of the apparatus, system, and method include at least one processor; at least one memory storing instructions executable by the at least one processor; an outline encoder including parameters stored in the at least one memory and trained to encode input data to obtain control guidance, where the input data includes an outline image and a color hint; and an image generator including parameters stored in the at least one memory and trained to generate a synthesized image based on the control guidance, where the synthesized image depicts an object having a shape based on the outline image and a color based on the color hint.

### BRIEF DESCRIPTION OF THE DRAWINGS

FIG. 1 shows an example of a colorization system according to aspects of the present disclosure.

FIG. 2 shows an example of a colorization apparatus according to aspects of the present disclosure.

FIG. 3 shows an example of a graphical user interface (GUI) according to aspects of the present disclosure.

FIG. 4 shows an example of a pipeline for colorizing a vector image according to aspects of the present disclosure.

FIG. 5 shows an example of image generation with and without a control network according to aspects of the present disclosure.

FIG. 6 shows an example of a method for interactive colorization of vector graphics according to aspects of the present disclosure.

FIG. 7 shows an example of a method for coloring an outline image according to aspects of the present disclosure.

FIG. 8 shows an example of a pipeline for generating training data according to aspects of the present disclosure.

FIG. 9 shows an example of a pipeline for training a colorization apparatus according to aspects of the present disclosure.

FIG. 10 shows an example of a method for training an outline encoder according to aspects of the present disclosure.

FIG. 11 shows an example of a computing device according to aspects of the present disclosure.

### DETAILED DESCRIPTION

The following relates to coloring pixel images and vector images. A vector image format refers to a type of digital graphic representation that utilizes mathematical equations to define paths and shapes, rather than mapping individual pixels, facilitating scalable and resolution-independent rendering of the image elements. This format allows for precise manipulation of image attributes such as colors, shapes, and outlines without degradation in quality, making it a preferred format for logos and illustrations.

There are generally two approaches to vector colorization: rule-based approaches and machine learning (ML)-based approaches. Rule-based techniques utilize predetermined algorithms and heuristics to add or change colors in vector images. Rule-based techniques include outline colorization and color propagation and attempt to identify the boundaries of shapes and regions and propagate color up to the boundary. ML-based approaches train models to learn relationships between inputs and a desired output.

Rule-based approaches often require a user to provide a thorough color basis for the techniques to work accurately. Techniques such as those that propagate colors based on the texture information tend to create inaccurate fills particularly when the input color strokes are sparse. When the results are inaccurate, the user will spend substantial time and effort on adjustments and refinements to ensure the final output meets the desired quality and accuracy. Furthermore, such approaches do not generate diverse variants for a user to choose from, beyond merely swapping colors within the color palette.

Apart from rule-based methods, many advancements have been made through the integration of deep learning methods, predominantly GAN-based methodologies. These methods generally encompass GAN inversion of an input image, where the inversion latent serves as a foundation that can be manipulated to generate a target image. Typically, an input sketch forms the basis of these methods, with the integration of various losses and regularization measures to mitigate artifacting and mode collapse. However, it is noted that GAN-based methods will typically fail for highly complex sketches, often spilling colors into different regions, and can fail to apply the user's color hints appropriately. Furthermore, GAN inversion-based methods typically require large computational overhead, making them infeasible for real-time editing. While some approaches utilize a diffusion model for the image-to-image translation task, they often require re-training for each individual image and are prone to issues such as catastrophic forgetting, thereby posing challenges in achieving diverse outputs.

Embodiments of the present disclosure, by contrast, utilize a diffusion network and an outline encoder generation. An input sketch including color hints, such as dots or small strokes of color from a user, is provided to the outline encoder. Some embodiments of the outline encoder include a control network, though another separately trainable network configured to condition the image generation process may be used. A control network is a trainable copy of an image encoder from a diffusion network. The control network provides adaptable, unlocked encoding layers that can be trained independently, enabling the diffusion process to be guided by both the locked, pre-trained diffusion model and the trainable copy. This enables adaptability from the specialized outline encoder with the robustness and consistency of maintaining the original diffusion model. Additionally, some embodiments are further configured to condition the generation with a text description in addition to the color hints.

Embodiments train the control network in a training phase using training data. The training data may include text and image pairs. In some cases, a text and image pair include an outline of the image, a color hint for the image, and a full color image. Embodiments are configured to process the full color image in the training data to generate the outline and the color hint. During training of the control network, embodiments may randomly drop colors from the color image, thereby training the model to reconstruct images with missing colors. Additionally, embodiments may blur the generated color hints in the training data to train the model to generalize outside of the regions in the outline. In this way, the control network is configured to learn intrinsic features from the color hints and to apply colors to areas that are devoid of hints, enabling the colorization system to colorize sections without color hints.

Some embodiments further include an upsampling component such as a GAN network. The upsampling component may increase the resolution of the output from the diffusion model. Embodiments may then transfer the colors from the upscaled image back to the outline or vector image using a stenciling process. Through these aspects, embodiments improve image generation systems by enabling accurate colorization of vector images in real-time based on sparse input color hints.

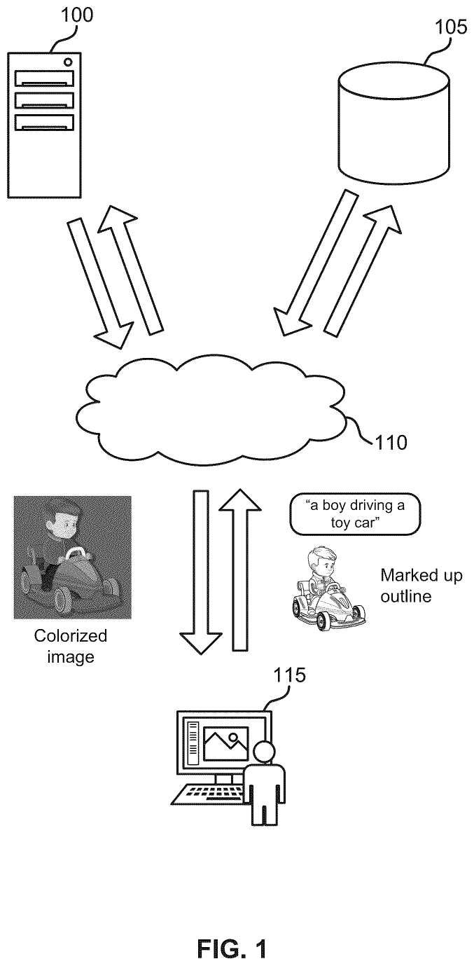

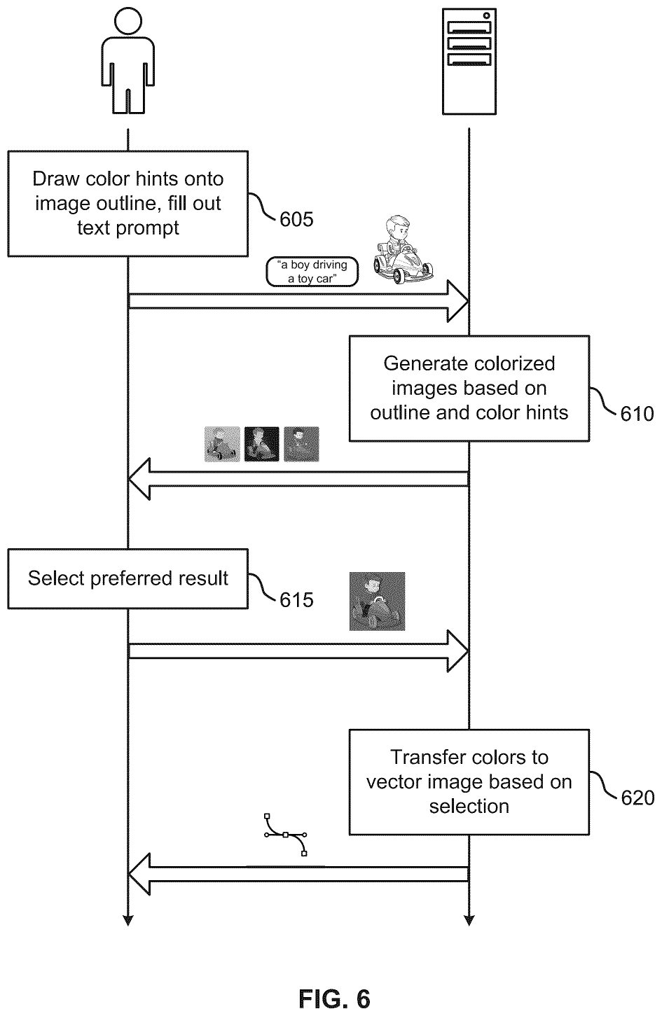

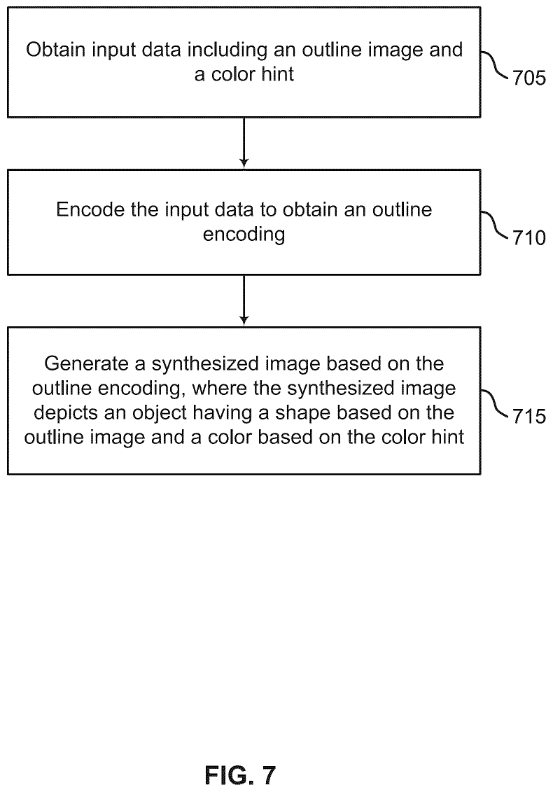

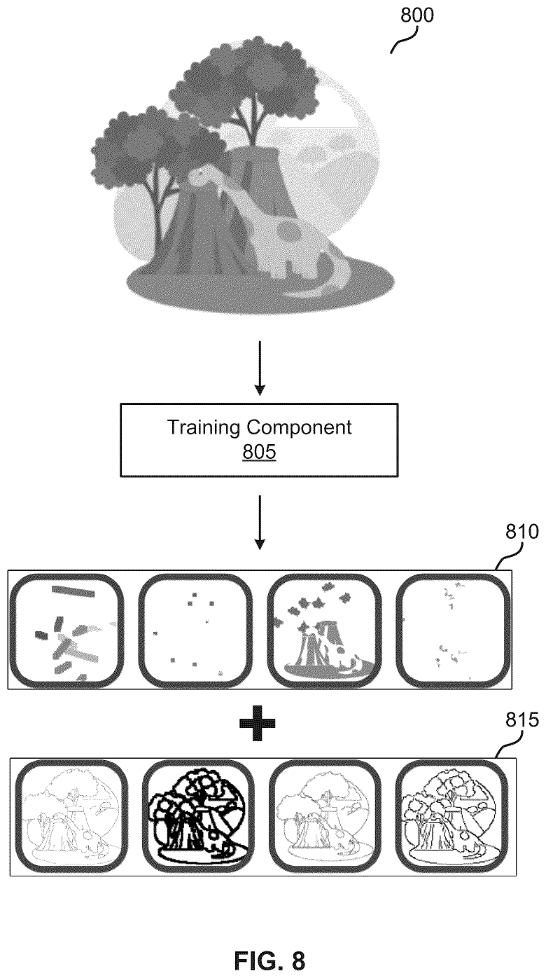

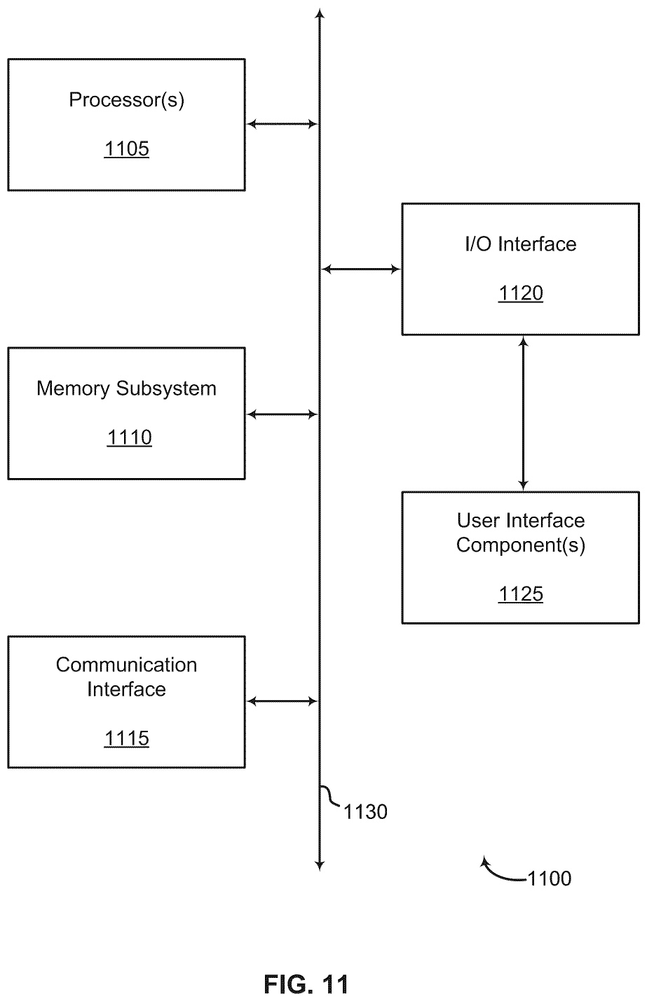

A colorization system is described with reference to FIGS. 1-5. Methods for colorizing images are described with reference to FIGS. 6-7. Training methods are described with reference to FIGS. 8-10. A computing device configured to implement a colorization apparatus is described with reference to FIG. 11.

### Colorization System

An apparatus for image colorization is described. One or more aspects of the apparatus include at least one processor; at least one memory storing instructions executable by the at least one processor; an outline encoder including parameters stored in the at least one memory and trained to encode input data to obtain control guidance, where the input data includes an outline image and a color hint; and an image generator including parameters stored in the at least one memory and trained to generate a synthesized image based on the control guidance, where the synthesized image depicts an object having a shape based on the outline image and a color based on the color hint.

In some aspects, the image generator comprises a U-Net architecture. In some aspects, the outline encoder comprises a ControlNet architecture. In some aspects, the outline encoder comprises a tuned copy of an encoder of the image generator. In some aspects, the outline encoder comprises an image adapter network, such as a vision transformer (ViT) network. Some examples of the apparatus, system, and method further include a text encoder configured to encode a text prompt to obtain a text encoding.

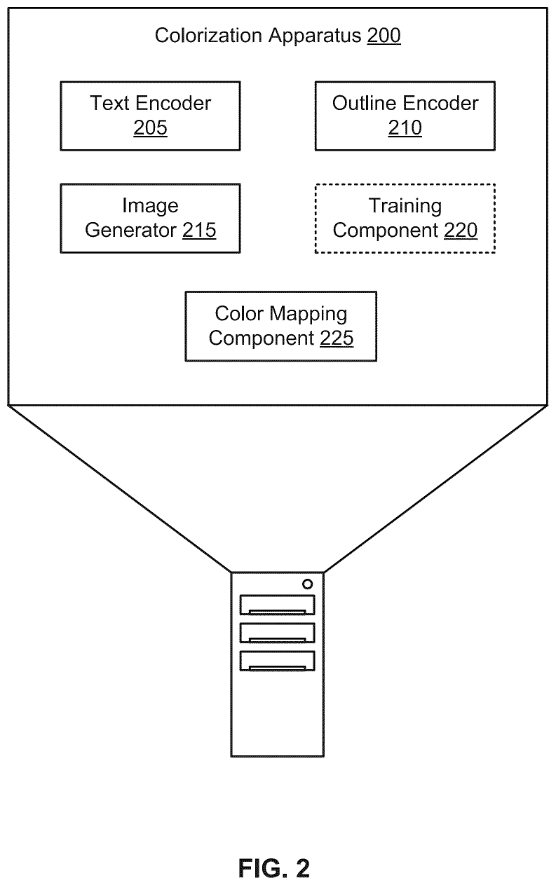

FIG. 1 shows an example of a colorization system according to aspects of the present disclosure. The example shown includes colorization apparatus 100, database 105, network 110, and user interface 115. Colorization apparatus 100 is an example of, or includes aspects of, the corresponding element described with reference to FIG. 2.

In an example process, a user provides color hints over an outline image via user interface 115. For example, the user may select a color using a brush tool and paint a dot or a stroke within one or more regions of the outline image. In some cases, the user also provides a text prompt. Colorization apparatus 100 then processes the outline image with color hints and the text prompts to generate a colorized image which depicts a fully colorized version of the outline image. According to some aspects, the system provides the image in a vector format.

Embodiments of colorization apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

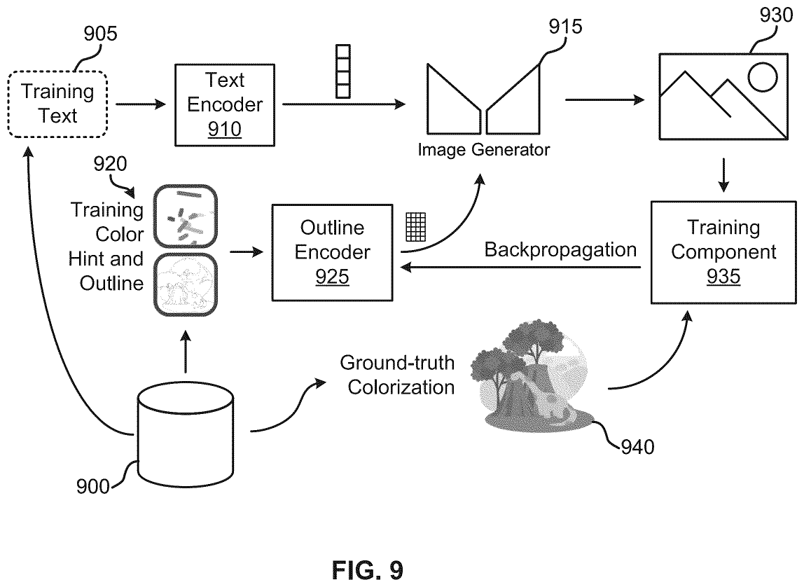

Database 105 stores information used by the colorization system, such as outline images, training data, machine learning (ML) model parameters, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with a database controller. In other cases, a database controller may operate automatically without user interaction. Database 105 is an example of, or includes aspects of, the corresponding element described with reference to FIG. 9.

Network 110 facilitates the transfer of information between colorization apparatus 100, database 105, and user interface 115. Network 110 may be referred as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

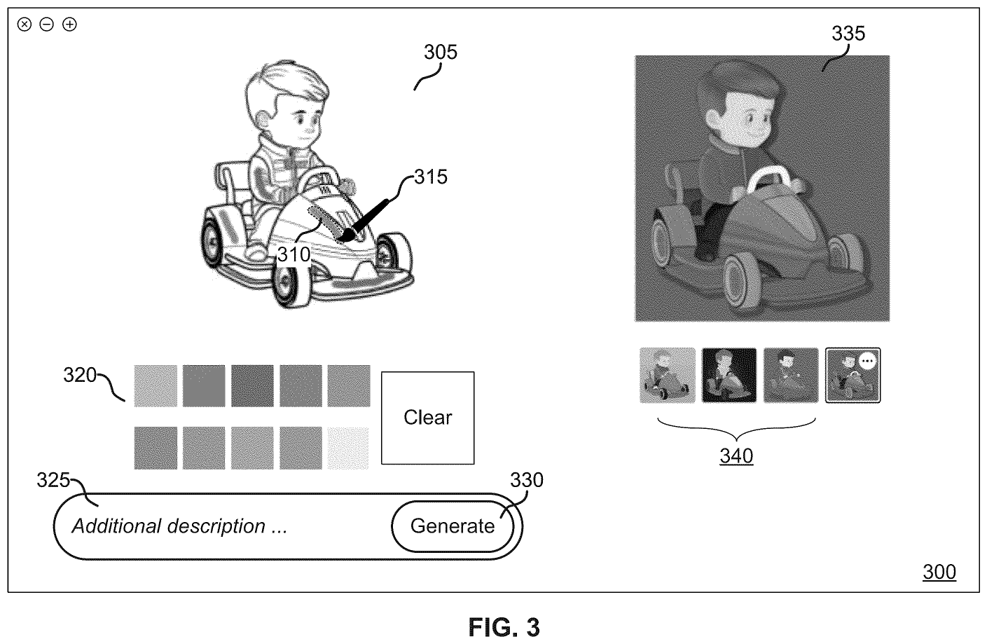

User interface 115 enables a user to interact with a device. In some embodiments, the user interface 115 may include an audio device, such as an external speaker system, an external display device such as a display screen, or an input device (e.g., a remote-control device interfaced with the user interface directly or through an IO controller module). In some cases, a user interface 115 may be a graphical user interface 115 (GUI). For example, the GUI may be a part of a web application, or a part of a program such as a multilayer design document editing software. User interface 115 is an example of, or includes aspects of, the corresponding element described with reference to FIG. 3.

FIG. 2 shows an example of a colorization apparatus 200 according to aspects of the present disclosure. The example shown includes colorization apparatus 200, text encoder 205, outline encoder 210, image generator 215, training component 220, and color mapping component 225. Colorization apparatus 200 is an example of, or includes aspects of, the corresponding element described with reference to FIG. 1.

Embodiments of colorization apparatus 200 include several components and sub-components. These components are variously named and are described so as to partition the functionality enabled by the processor(s) and the executable instructions included in the computing device used in colorization apparatus 200 (such as the computing device described with reference to FIG. 11). In some examples, the partitions are implemented physically, such as through the use of separate circuits or processors for each component. In some examples, the partitions are implemented logically via the architecture of the code executable by the processors.

In some embodiments, components of colorization apparatus 200 such as text encoder 205, outline encoder 210, and image generator 215 include an artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Text encoder 205 is configured to transform an input text into a text embedding. A text embedding is a data-rich vector representation of the input text. As used herein, “embedding” and “encoding” are synonymous. In some cases, text encoder 205 includes an ANN that is trained to generate text embeddings that capture semantic and contextual meaning from input texts. Embodiments of text encoder 205 include a transformer-based ANN.

A transformer or transformer network is a type of neural network model used for natural language processing tasks. A transformer network transforms one sequence into another sequence using an encoder and a decoder. The encoder and the decoder include modules that can be stacked on top of each other multiple times. The modules comprise multi-head attention and feed forward layers. The inputs and outputs (target sentences) are first embedded into an n-dimensional space. Positional encodings of the different words (i.e., give every word/part in a sequence a relative position since the sequence depends on the order of its elements) are added to the embedded representation (n-dimensional vector) of each word. In some examples, a transformer network includes an attention mechanism, where the attention looks at an input sequence and decides at each step which other parts of the sequence are important. The attention mechanism involves queries, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence as Q. However, for the attention module that is taken into account the encoder and the decoder sequences, V is different from the sequence represented by Q. In some cases, values in V are multiplied and summed with some attention-weights a.

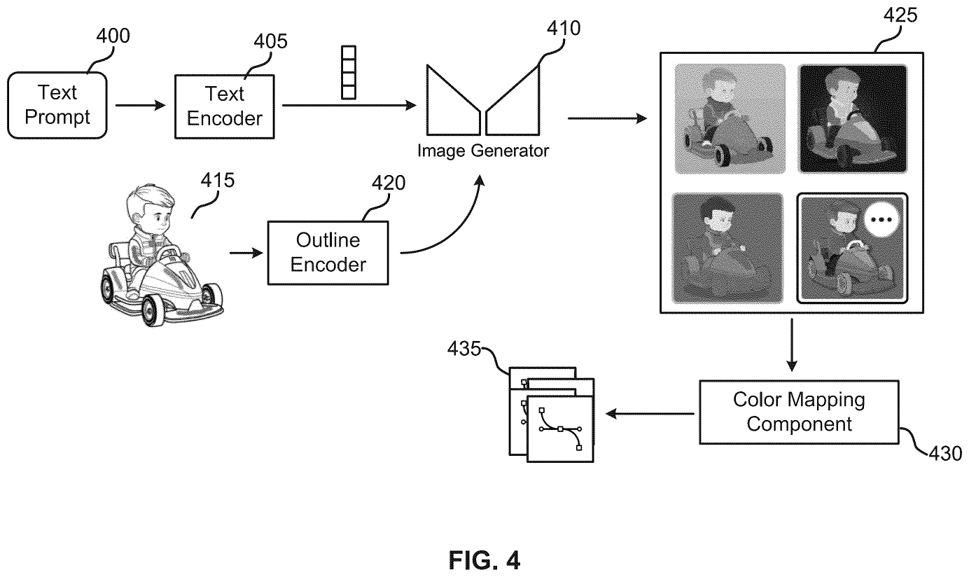

According to some aspects, text encoder 205 encodes the text prompt to obtain a text encoding (also known as a “text embedding), where the synthesized image is generated based on the text encoding. Text encoder 205 is an example of, or includes aspects of, the corresponding element described with reference to FIGS. 4 and 9.

Outline encoder 210 is configured to process an outline image and color hints generate control guidance. In some examples, outline encoder 210 provides the control guidance as an input to a decoder layer of the image generator 215. In some aspects, the input data includes a single image that includes the outline image and the color hint. In some aspects, the input data to the outline encoder includes a color hint image that is separate from the outline image and that includes the color hint. Embodiments of outline encoder 210 include an ANN which is trained along with image generator 215. For example, in a training phase, both outline encoder 210 image generator 215 operate to generate predicted images, and the predicted images are compared with ground-truth training images, and parameters of outline encoder 210 are updated based on the comparison, e.g. via backpropagation, while parameters of image generator 215 are held fixed.

According to some aspects, outline encoder 210 includes parameters stored in the memory of the colorization system and is trained to encode input data to obtain control guidance, where the input data includes an outline image and a color hint. In some cases, outline encoder 210 concatenates the outline image and color hint data with a random noise map to form an input tensor, and the input tensor is then processed by outline encoder 210 to generate the control guidance. Some embodiments of outline encoder 210 include a ControlNet architecture. Some embodiments of outline encoder 210 include a tuned copy of an encoder of the image generator 215. Embodiments are not limited thereto, however, and some embodiments of outline encoder 210 include an image adapter network. An image adapter network is a separate encoder, such as a Vision Transformer (ViT) network, which is coupled to image generator 215 during training. A vision transformer (e.g., a ViT model) is a neural network model configured for computer vision tasks. Unlike CNNs, ViTs use a transformer architecture, which was originally developed for natural language processing (NLP) tasks. ViTs break down an input image into a sequence of patches, which are then fed through a series of transformer encoder layers. The output of the final encoder layer is fed into a multi-layer perceptron (MLP) head for classification. ViTs can capture long-range dependencies between patches without relying on spatial relationships. Outline encoder 210 is an example of, or includes aspects of, the corresponding element described with reference to FIGS. 4 and 9.

Image generator 215 is configured to generate synthetic images. Image generator 215 may include a generative ANN that is configured to generate image content based on a text prompt. For example, embodiments of image generator 215 include a diffusion network.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, a guided latent diffusion model may take an original image in a pixel space as input and apply an image encoder to convert the original image into original image features in a latent space. Then, a forward diffusion process gradually adds noise to the original image features to obtain noisy features (also in latent space) at various noise levels.

Next, a reverse diffusion process (e.g., a U-Net ANN) gradually removes the noise from the noisy features at the various noise levels to obtain denoised image features in latent space. In some examples, the denoised image features are compared to the original image features at each of the various noise levels, and parameters of the reverse diffusion process of the diffusion model are updated based on the comparison. Finally, an image decoder decodes the denoised image features to obtain an output image in pixel space. In some cases, an output image is created at each of the various noise levels. The output image can be compared to the original image to train the reverse diffusion process.

In some cases, image encoder and image decoder are pre-trained prior to training the reverse diffusion process. In some examples, they are trained jointly, or the image encoder and image decoder and fine-tuned jointly with the reverse diffusion process.

The reverse diffusion process can also be guided based on a text prompt, or another guidance prompt, such as an image, a layout, a segmentation map, or an embedding output from outline encoder 210. In some cases, the guidance prompt is further processed to produce guidance features. The guidance features can be combined with the noise at one or more layers of the reverse diffusion process to ensure that the output image includes content described by the text prompt. For example, guidance features can be combined with the noise features using a cross-attention block within the reverse diffusion process.

The following describes the reverse diffusion process used for generation. As described above, a diffusion model can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${P}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0, I) is the pure noise distribution as the reverse process takes the outcome of the forward process, a sample of pure noise, as input and Πₜ₌₁^{T}pθ(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \acute{x} is mapped back into the pixel space from the latent space as output. In some examples, x₀ represents an original input image with low image quality, latent variables x₁, . . . , x_{T} represent noisy images, and x represents the generated image with high image quality.

According to some aspects, image generator 215 generates a synthesized image based on the control guidance, where the synthesized image depicts an object having a shape based on the outline image and a color based on the color hint. In some examples, image generator 215 performs a reverse diffusion process during the generation. In some examples, image generator 215 obtains a noisy input image, where the control guidance is based on the noisy input image. The noisy input image may be referred to as a “noise map”. In some examples, image generator 215 encodes a diffusion timestep to obtain a timestep encoding, where the synthesized image is generated based on the timestep encoding. In some examples, image generator 215 generates multiple different synthesized images based on the input data and a set of different random seeds. Image generator 215 is an example of, or includes aspects of, the corresponding element described with reference to FIGS. 4 and 9.

Training component 220 is configured to update parameters of colorization apparatus 200 during training, and to create and augment training data. According to some aspects, training component 220 trains the outline encoder 210 to generate colored images based on the training data including a training image, a training text, a training outline, and a training color hint. In some examples, training component 220 generates additional training data by augmenting the ground-truth image. In some aspects, the training outline and the training color hint are generated based on the ground-truth image. For example, training component 220 may perform canny edge detection and morphological operations on the ground-truth image to generate the training outline, and may perform random square patch, random walk, or random stroke techniques to generate the color hint. Additional details regarding the training data creation will be described with reference to FIG. 8.

In some examples, training component 220 trains the outline encoder 210 includes a diffusion-based training process, such as the one described with reference to Equations 1 and 2 above. Training component 220 is an example of, or includes aspects of, the corresponding element described with reference to FIGS. 8 and 9.

Some embodiments of the colorization apparatus 200 further include an upsampling network. The upsampling network is configured to upscale an output of the image generator. The upsampling network may be a part of image generator 215, or may be a separate component. Some embodiments of the upsampling network include a Generative Adversarial Network (GAN)-based upsampler. GAN-based upsamplers are trained during a process that configures them to map lower-resolution images to higher-resolution equivalents utilizing a training dataset comprised of paired low and high-resolution images. Specifically, the generator in the GAN learns to fabricate higher-resolution images that the discriminator cannot differentiate from authentic high-resolution counterparts.

Color mapping component 225 is configured to colorize a vector image using the color information within the synthesized image. According to some aspects, color mapping component 225 performs a stenciling process to transfer the color from the synthesized image to a vector image, thereby creating a colorized vector image. Examples of the stenciling process include identifying a plurality of surfaces in a vector image (e.g., a black and white “line drawing” vector image) and mapping corresponding regions from the synthesized image to the surfaces of the vector image. The color mapping component 225 may then obtain color information for each surface from the synthesized image in its corresponding region and transfer the color to the vector image to generate the colorized vector image. Color mapping component 225 is an example of, or includes aspects of, the corresponding element described with reference to FIG. 4.

FIG. 3 shows an example of a graphical user interface 300 (GUI) according to aspects of the present disclosure. The example shown includes GUI 300, outline 305, color hint 310, color hint applicator 315, color palette 320, text field 325, generate button 330, colorized image 335, and variants 340. GUI 300 is an example of, or includes aspects of, the corresponding element described with reference to FIG. 1.

GUI 300 enables a user to manually annotate color hints, such as color hint 310, onto an outline image such as outline 305. Outline 305 may be a rasterized image. For example, a database may store several outline vector images, where each image is a black and white image containing an outline of a character, shape, or scene. A user may select one of the outline vector images for editing (or may upload their own), at which point the system will rasterize the outline vector image into pixel data to produce outline 305.

Then, using GUI 300, a user may select a brush tool such as color hint applicator 315, and select a color with which to draw from color palette 320. The user can then add color hint 310 to outline 305 via the interface. Optionally, the user may add a description of the image to text field 325, which will lend additional semantic information to the colorization process, but this is not required. Once the user has applied color hints to one or more regions of outline 305, the user may select the generate button 330, and the system will produce a colorized image 335 and additional colorized images as variants 340. Note that the user can provide sparse color hints; the system will generate colorized portions within the regions of outline 305 even if the regions do not include color hints. The system may also vectorize the colorized image 335, e.g., under direction from the user, using the color mapping process described above to transfer colors from colorized image 335 to a vector version of outline 305.

FIG. 4 shows an example of a pipeline for colorizing a vector image according to aspects of the present disclosure. The example shown includes text prompt 400, text encoder 405, image generator 410, outline image with color hints 415, outline encoder 420, colorized images 425, color mapping component 430, and colorized vector images 435.

Text encoder 405, image generator 410, and outline encoder 420 are examples of, or include aspects of, the corresponding elements described with reference to FIGS. 2 and 9. Color mapping component 430 is an example of, or includes aspects of, the corresponding element described with reference to FIG. 2.

FIG. 4 illustrates an example of how the colorization system works beneath the GUI described with reference to FIG. 3. In this example, the user provides both text prompt 400 and outline image with color hints 415. Text encoder 405 encodes the text prompt 400 to generate a text embedding (“encoding”), which is then input to image generator 410 to condition its generation process—i.e., the text embedding is an example of the “guidance features” described in the reverse diffusion process above with reference to FIG. 2. In some aspects, outline image with color hints 415 are combined with a noise map and then input to outline encoder 420, which generates control guidance. The control guidance is applied at one or more stages of the encoder of image generator 410. According to some aspects, the control guidance constrains the image generation to produce the shapes and outlines from the original outline image.

Image generator 410 generates colorized images 425 based on the control guidance and the text embedding. In some cases, a user selects an image for vectorization, e.g., the bottom right option in FIG. 4. This image is passed to color mapping component 430, which then performs the stenciling techniques described with reference to FIG. 2 to generate colorized vector images.

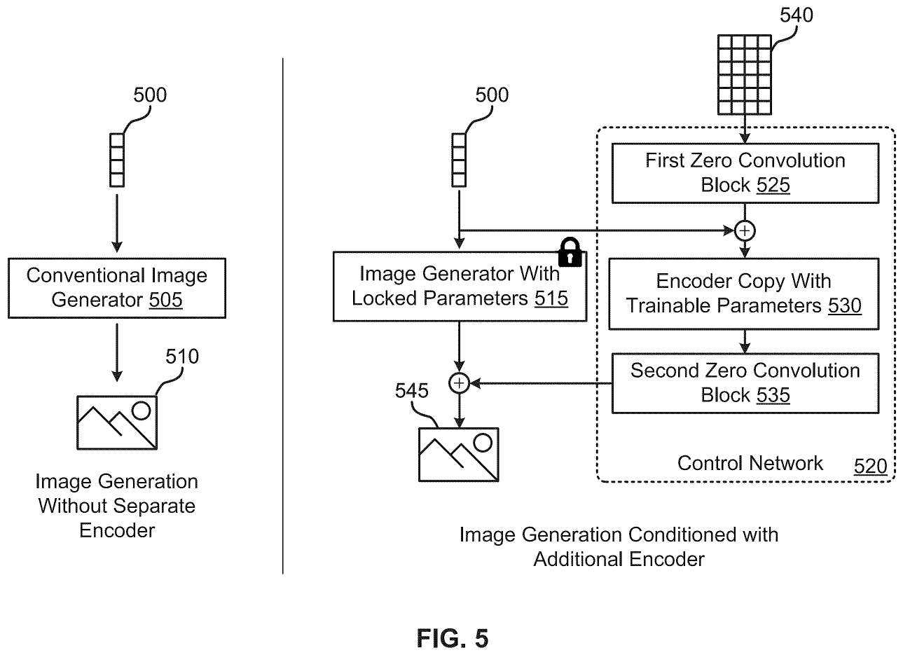

FIG. 5 shows an example of image generation with and without a control network 520 according to aspects of the present disclosure. The example shown includes text embedding 500, conventional image generator 505, pixel data 510, image generator with locked parameters 515, control network 520, condition tensor 540, and conditioned pixel data 545.

In a conventional example, e.g., the process shown to the left, conventional image generator 505 generates pixel data 510. The conventional image generator 505 may be conditioned during its generation through text embedding 500. Embodiments of conventional image generator 505 include a pre-trained generative model such as a stable diffusion model. In such cases, conventional image generator 505 requires re-training for every single colorized image so that the image's outline and shape are preserved. This re-training can cause the model to forget concepts it learned during training, such as the semantic context of various shapes in the image. The model may, for example, not know how to properly color animals, buildings, etc., unless explicit color hints are provided for every region. Additionally, re-training uses a large computational overhead, and prohibits real-time colorization by a user.

By contrast, the colorization system described herein includes an outline encoder. In the example shown in FIG. 5., the outline encoder is implemented as control network 520. The control network 520 enables the colorization system to retain the deep knowledge and diverse outputs from an image generation model such as a diffusion network, without requiring re-training for each image, enabling real-time colorization.

In one aspect, control network 520 includes first zero convolution block 525, encoder copy with trainable parameters 530, and second zero convolution block 535. Control network 520 may be or include aspects of ControlNet. ControlNet is a neural network structure to control image generation models by adding extra conditions. In some embodiments, a ControlNet architecture copies the weights from some of the neural network blocks of the image generator with locked parameters 515 to create a “trainable” copy, such as the trainable copy of the encoder from the image generator. The trainable copy learns the condition. In the context of the colorization system, the trainable copy learns to generate an embedding that conditions the image generator to create images that include the structure from the provided outline and that include colors from the provided color hints, as well as to infer additional colors not specified by the color hints. The “locked” copy, i.e., image generator with locked parameters 515, preserves the parameters of the original generative model such as a stable diffusion model. The trainable copy can be tuned with a small dataset of image pairs, while preserving the locked copy ensures that the original model is preserved and does not lose the knowledge or diversity from its pretraining.

In some embodiments, one or more zero convolution layers are added to the trainable copy, such as first zero convolution block 525 and second zero convolution block 535. A “zero convolution” layer is 1×1 convolution with both weight and bias initialized as zeros. Before training, the zero convolution layers output all zeros. Accordingly, the ControlNet will not cause any distortion. As the training proceeds, the parameters of the zero convolution layers deviate from zero and the influence of the ControlNet on the output grows.

For example, a ControlNet architecture can be used to control a diffusion U-Net (i.e., to add controllable parameters or inputs that influence the output), such as a U-net included in image generator with locked parameters 515. For example, condition tensor 540 may include a noise map concatenated with the outline image and color hints, and input to the ControlNet architecture. Then zero convolution layers can be added. The output of the control network e.g., the “control guidance” described herein, can be input to decoder layers of the U-Net. Accordingly, the conditioned pixel data 545 produced by the colorization system described herein will include the structure from the outline image, colors from the color hints, and additional colors predicted by the image generator where there were no color hints. All the while, the system maintains the diversity and the semantic understanding provided by image generator with locked parameters 515.

### Image Colorization

A method for image colorization is described. One or more aspects of the method include obtaining input data including an outline image and a color hint, where the color hint comprises a colored portion corresponding to a region of the outline image; encoding, using an outline encoder, the input data to obtain control guidance; and generating, using an image generator, a synthesized image based on the control guidance, where the synthesized image depicts an object having a shape based on the outline image and a color based on the color hint.

Some examples of the method, apparatus, non-transitory computer readable medium, and system further include providing the control guidance as an input to a decoder layer of the image generator. Some examples further include obtaining a text prompt. Some examples further include encoding the text prompt to obtain a text encoding, where the synthesized image is generated based on the text encoding.

Some examples of the method, apparatus, non-transitory computer readable medium, and system further include performing a reverse diffusion process. A reverse diffusion process is described in detail with reference to FIG. 2. Some examples of the method, apparatus, non-transitory computer readable medium, and system further include obtaining a noisy input image for the image generator, where the control guidance is based on the noisy input image. Some examples include identifying a diffusion timestep. Some examples further include encoding the diffusion timestep to obtain a timestep encoding, where the synthesized image is generated based on the timestep encoding.

In some aspects, the input data comprises a single image that includes the outline image and the color hint. In some embodiments, the input data comprises a color hint image that is separate from the outline image and that includes the color hint. In some cases, a noise map, e.g., a noisy image, is combined with the outline and the color hint, and this combined tensor is included in the input data. Some examples of the method, apparatus, non-transitory computer readable medium, and system further include generating a plurality of synthesized images based on the input data and a plurality of different random seeds, respectively.

FIG. 6 shows an example of a method 600 for interactive colorization of vector graphics according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, a user draws color hints onto an image outline and fills out a text field with a text prompt. The user may do so via a user interface as described with reference to FIGS. 1 and 3. The text prompt may be, for example, a short description of the image the user wishes to colorize.

At operation 610, the system generates colorized images based on the outline and the color hints. For example, the system may encode the image outline and the color hints using an outline encoder according to the process described with reference to FIGS. 4-5 to generate control guidance. The system may further encode the text prompt to generate a text encoding. Then the system uses the control guidance and the text encoding as conditions for a diffusion-based generative process. The generated images include colors as specified by the color hints, and structure from the outline image. In some cases, the system generates different variants using different seeds. The different seeds may, for example, influence the noisy image used at the beginning of the generation process. According to some aspects, all of the different variants include the same structure from the image outline but differ from each other by their coloring.

At operation 615, the user selects a preferred result. For example, the user may use the user interface to select one of the colorized images produced by the system.

At operation 620, the system transfers colors to a vector image based on the selection. For example, a color mapping component may identify regions in the selected image and map them to regions of a vector image. According to some aspects, the base vector image is a vector format version of the outline image. The system produces a colorized vector image by editing the base vector image with the color transfer process.

FIG. 7 shows an example of method 700 for coloring an outline image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains input data including an outline image and a color hint, where the color hint includes a colored portion corresponding to a region of the outline image. The color hint may be provided by a user via a user interface. The color hint can be, for example, a dot or a stroke mark within a region of the outline image, where the mark includes a color the user wishes to keep in the corresponding region of the colorized image.

At operation 710, the system encodes, using an outline encoder, the input data to obtain control guidance. In some cases, the encoding may include processing the input data by combining the input data with image data and encoding the combined data using a control network. According to some aspects, the outline encoder is a neural network that operates in parallel to an image generator network. Some embodiments of the outline encoder include a copy of an encoder from the image generator network with trainable parameters. In some cases, zero convolution layers are added to the copy, where the zero convolution layers also include trainable parameters.

At operation 715, the system generates, using the image generator, a synthesized image based on the control guidance, where the synthesized image depicts an object having a shape based on the outline image and a color based on the color hint. In some cases, the operations of this step refer to, or may be performed by, an image generator as described with reference to FIGS. 2, 4, and 9. For example, the image generator may perform a reverse diffusion process to generate the synthesized image. According to some aspects, the control guidance is applied at one or more decoding steps of the image generator to condition the generation process to include the shape and the color.

### Training

A method for image colorization is described. One or more aspects of the method include obtaining training data including a training outline image, a training color hint, and a ground-truth image corresponding to the training outline image and the training color hint; initializing an outline encoder using parameters of an image generator; and training the outline encoder to generate colored images, where the training is based on the training data. In some aspects, the outline encoder is trained using a fixed copy of the image generator.

In some aspects, the training outline and the training color hint are generated based on the ground-truth image. Some examples of the method, apparatus, non-transitory computer readable medium, and system further include generating additional training data by augmenting the ground-truth image.

FIG. 8 shows an example of a pipeline for generating training data according to aspects of the present disclosure. The example shown includes training image 800, training component 805, color hint variants 810, and outline variants 815. Training component 805 is an example of, or includes aspects of, the corresponding element described with reference to FIGS. 2 and 9.

According to some aspects, a colorization system as described herein is trained on training data including a ground-truth image, an outline of the ground-truth image, and color hints corresponding to the outline. Some examples further include a training text which describes the ground-truth image. Thus, embodiments of the colorization system are trained on tuples of (ground-truth image, training outline, color hints, training text). The ground-truth image, the outline, and the color hints may each be RGB images or RGBA images, though embodiments are not limited thereto, and other color spaces may be used.

In this example, training component 805 obtains training image 800 from a memory such as a database. Then, training component 805 processes training image 800 to generate outline variants 815. For example, training component 805 may perform Canny edge detection to produce the outline image. The training component 805 may apply transformations to training image 800 before the edge detection, such as resizing, applying Gaussian blur, and morphological operations such as erosion and dilation. Further, training component 805 may randomly set parameters of the Canny edge detection module to yield different outline variants. Lastly, training component 805 may apply transformations after the edge detection such as blur and morphological operations. In some examples, the final outline output is color inverted. In this way, training component 805 generates many outline variants 815 from a given training image 800.

Training component 805 similarly generates different variants of color hints from a given training image 800. For example, training component 805 may sample colors from training image 800 to generate sparse color hints. One sampling method is referred to as “random square patch” and involves randomly sampling different sized squares of color from training image 800. Another sampling method is referred to as “random walk” and involves choosing a random location in training image 800, choosing a direction randomly, and extracting a line of color along the direction for a random length. Another method is “random strokes”, in which a stroke of random width and length is drawn in a random direction using the color present at the originating location. According to some aspects, training component 805 further drops some colors from the training image 800 and performs the color sampling methods thereafter. In some cases, training component 805 applies Gaussian blur to the extracted color hints. The application of the blur allows the colorization system to generalize to other regions outside of the outline and predict colors accurately in those regions. The extraction and adjustment of outlines and color hints from an image to generate training data is sometimes referred to as “data augmentation”.

FIG. 9 shows an example of a pipeline for training a colorization apparatus according to aspects of the present disclosure. The example shown includes database 900, training text 905, text encoder 910, image generator 915, training color hint and outline 920, outline encoder 925, predicted image 930, training component 935, and ground-truth image 940.

Database 900 is an example of, or includes aspects of, the corresponding element described with reference to FIG. 1. Text encoder 910, image generator 915, and outline encoder 925 are examples of, or include aspects of, the corresponding elements described with reference to FIGS. 2 and 4. Training component 935 is an example of, or includes aspects of, the corresponding element described with reference to FIGS. 2 and 8.

In this example, database 900 provides training data including training text 905, training color hint and outline 920, and ground-truth image 940. According to some aspects, training color hint and outline 920 are extracted from ground-truth image 940 according to the processes described with reference to FIG. 8.

The training text 905 is input to text encoder 910 to generate a text encoding, which is then input as guidance to image generator 915. The training color hint and outline 920, which can be combined into a single image or kept as separate images, are input to outline encoder 925 which generates control guidance. In some cases, image generator 915 includes a diffusion model which uses the text encoding as guidance features to generate predicted image 930 in a reverse diffusion process. The control guidance from outline encoder 925 may be input to image generator 915 at one or more steps of the reverse diffusion process, such as one or more of the decoding blocks. Additional detail regarding the reverse diffusion process is described with reference to FIG. 2.

The image generator 915 generates predicted image 930 via the reverse diffusion process. Training component 935 then compares predicted image 930 with ground-truth image 940 and computes a loss function based on the comparison. The loss function may be a pixel-based loss function or a feature-based loss function, or a combination. Then, training component 935 updates parameters of outline encoder 925 based on the computed loss function via, e.g., backpropagation. According to some aspects, parameters of image generator 915 are held fixed while parameters of outline encoder 925 are updated in this training phase.

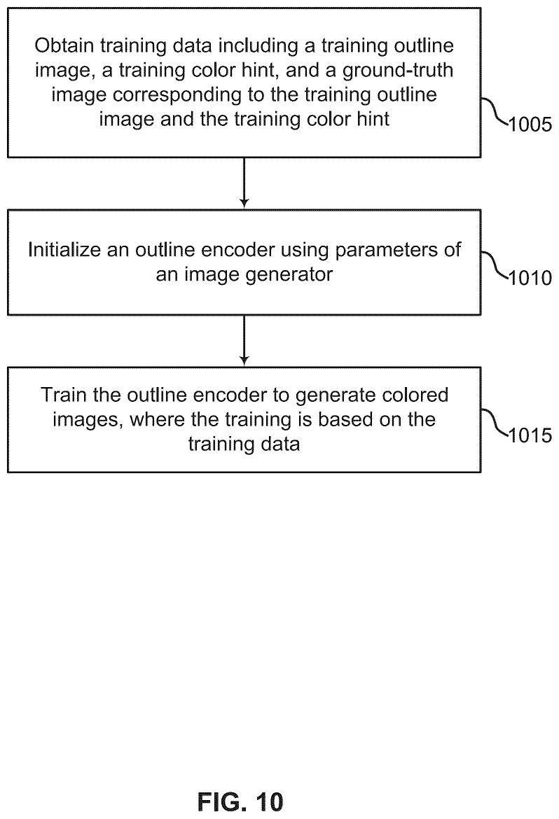

FIG. 10 shows an example of method 1000 for training an outline encoder according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains training data including a training outline image, a training color hint, and a ground-truth image corresponding to the training outline image and the training color hint. In some cases, the operations of this step refer to, or may be performed by, a colorization apparatus as described with reference to FIGS. 1 and 2. The colorization apparatus may obtain the training data from a database. In some cases, the training color hint and the training outline image are produced from the ground-truth image by a training component using the processes described with reference to FIG. 8.

At operation 1010, the system initializes an outline encoder using parameters of an image generator. For example, in some cases the system copies parameters from an encoder of a pre-trained image generator, and this copy is used as the outline encoder. In some examples, zero convolution blocks are added before and after the encoding block, and this combined network is used as the outline encoder.

At operation 1015, the system trains the outline encoder to generate colored images, where the training is based on the training data. In some cases, the operations of this step refer to, or may be performed by, a training component as described with reference to FIGS. 2, 8, and 9. Additional details regarding the training process is described with reference to FIG. 8.

FIG. 11 shows an example of a computing device 1100 according to aspects of the present disclosure. The example shown includes computing device 1100, processor(s) 1105, memory subsystem 1110, communication interface 1115, I/O interface 1120, user interface component(s) 1125, and channel 1130.

In some embodiments, computing device 1100 is an example of, or includes aspects of, colorization apparatus 100 of FIG. 1. In some embodiments, computing device 1100 includes one or more processors 1105 that can execute instructions stored in memory subsystem 1110 to obtain input data including an outline image and a color hint, where the color hint comprises a colored portion corresponding to a region of the outline image; encode, using an outline encoder, the input data to obtain control guidance; and generate, using an image generator, a synthesized image based on the control guidance, where the synthesized image depicts an object having a shape based on the outline image and a color based on the color hint.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enables a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an outline image and a color hint, wherein the color hint comprises a colored portion corresponding to a region of the outline image;
processing, using an outline encoder, the outline image and the color hint to obtain control guidance for an image generator; and
generating, using the image generator, a synthesized image based on the control guidance, wherein the synthesized image depicts an object having a shape based on the outline image and a color based on the color hint.

2. The method of claim 1, wherein generating the synthesized image comprises:
providing the control guidance as an input to a decoder layer of the image generator.

3. The method of claim 1, further comprising:
obtaining a text prompt; and
encoding the text prompt to obtain a text encoding, wherein the synthesized image is generated based on the text encoding.

4. The method of claim 1, wherein generating the synthesized image comprises:
performing a reverse diffusion process.

5. The method of claim 4, wherein processing the outline image comprises:
obtaining a noisy input image for the image generator, wherein the control guidance is based on the noisy input image.

6. The method of claim 1, wherein generating the synthesized image comprises:
identifying a diffusion timestep; and
encoding the diffusion timestep to obtain a timestep encoding, wherein the synthesized image is generated based on the timestep encoding.

7. The method of claim 1, wherein:
a single image includes the outline image and the color hint.

8. The method of claim 1, wherein:
the color hint is included in a color hint image that is separate from the outline image.

9. The method of claim 1, further comprising:
generating a plurality of synthesized images based on the outline image and a plurality of different random seeds, respectively.

10. A method comprising:
obtaining training data including a training outline image, a training color hint, and a ground-truth colored image corresponding to the training outline image and the training color hint;
initializing an outline encoder using parameters of an image generator; and
training the outline encoder, using the training outline image and the training color hint, to generate control guidance for the image generator for generating colored images.

11. The method of claim 10, wherein:
the outline encoder is trained using a fixed copy of the image generator.

12. The method of claim 10, wherein:
the training outline and the training color hint are generated based on the ground-truth image.

13. The method of claim 10, wherein the training comprises:
providing the training outline image and the training color hint to the outline encoder;
providing an output of the outline encoder to the image generator; and
comparing an output of the image generator to the ground-truth colored image.

14. The method of claim 10, wherein:
training the outline encoder comprises a diffusion-based training process.

15. An apparatus comprising:
at least one processor;
at least one memory storing instructions executable by the at least one processor;
the apparatus further comprising an outline encoder including parameters stored in the at least one memory and trained to encode input data to obtain control guidance, wherein the input data includes an outline image and a color hint; and
an image generator including parameters stored in the at least one memory and trained to generate a synthesized image based on the control guidance, wherein the synthesized image depicts an object having a shape based on the outline image and a color based on the color hint.

16. The apparatus of claim 15, wherein:
the image generator comprises a U-Net architecture.

17. The apparatus of claim 15, wherein:
the outline encoder comprises a ControlNet architecture.

18. The apparatus of claim 15, wherein:
the outline encoder comprises a tuned copy of an encoder of the image generator.

19. The apparatus of claim 15, wherein:
the outline encoder comprises an image adapter network.

20. The apparatus of claim 15, further comprising:
a text encoder configured to encode a text prompt to obtain a text encoding.
